(19) United States
(12) Patent Application Publication
(10) Pub. No.: US 2011/0073201 A1
(43) Pub. Date: Mar. 31, 2011

(54) Method and Means for Installing a Union Nut around a Valve Port

(75) Inventors: Sadanori Matsui, Nagahama-shi (JP); Tatsuchi Tsunokawa, Nagahama (JP)

(73) Assignee: Matsui Kiki Industries, Ltd., Nigahama (JP)

(21) Appl. No.: 12/892,577

(22) Filed: Sep. 28, 2010

Related U.S. Application Data
(60) Provisional application No. 61/277,555, filed on Sep. 28, 2009.

(51) Int. Cl. F15D 1/00

(52) U.S. Cl. 137/561 R

(57) ABSTRACT

A service valve assembly for a tankless water heater incorporates one or more features that provide safer operation and easier installation of a valve assembly. Installation of a valve assembly is facilitated by foreshortening all perpendicularly protruding ports, thereby increasing the rotational freedom during installation. A main valve and a drain valve are intentionally distinguished from each other by providing different port sizes, valve handles and valve shapes that change the overall shape and characteristics of the valve assembly in such a way that accidental opening a drain port becomes much less likely. Installation can further be simplified by using a unique union nut that allows a service valve to be easily connected to an existing tankless water heater.

### RELATED U.S. APPLICATION DATA

This application claims the benefit of priority of U.S. Provisional Application No. 61/277,555, filed on Sep. 28, 2009, and titled “Method and Means for Installing a Union Nut around a Valve Port”, incorporated herein by reference in its entirety.

### BACKGROUND OF THE INVENTION

Service valve assemblies used to connect and control the flow of water through a tankless water heater are usually characterized by long valve bodies having numerous ports and at least 2 operable valves. A tankless water heater typically requires 2 service valves, a cold water service valve and a hot water service valve. The cold water service valve has a main valve for controlling the flow of cold water from a supply to the tankless water heater. The hot water service valve has a main valve for controlling the flow of hot water from the tankless water heater to one or more faucets. All service valve assemblies have a drain valve that allows the tankless water heater to be isolated from the supply and/or faucets such that service and maintenance operations can be performed on the tankless water heater. Drain ports open to the environment, so it is possible that someone opening a drain valve could be sprayed by water. If proper precautions are not taken, someone could accidentally open a hot water drain valve and be scalded.

Tankless water heaters are frequently installed into relatively small areas, so removing and replacing a bad service valve can be very difficult if there are long ports or protrusions off to the side of a valve assembly that prevent the valve assembly from rotating within a provided service area. To allow a valve assembly to be removable without needing to remove or damage an obstructing wall or structure, valve assemblies frequently are multi-piece assemblies. More piece parts usually means more opportunities for problems to develop between parts, and connectors always add bulk and length to an assembly. There is a need for a tankless water heater valve assembly that is safer to operate and easier to install.

### SUMMARY OF THE INVENTION

The present invention is a service valve assembly that incorporates one or more safety features that also allow a valve body to be more compact, easier to install and of simplified operation. Tankless water heaters are typically located in tight spaces that can make access difficult. Because installed water pipes are usually not able to be rotated, installation of a valve assembly is facilitated if the valve assembly can be rotated within an axis area. By optimally foreshortening all perpendicularly protruding ports, potential for rotational freedom is maximized. In order to accomplish these goals, the main valve and the service valve are intentionally distinguished from each other as follows: a main valve is provided on a large port with a large valve handle that is able to be turned with ease, such as a lever handle, while a service valve is provided on a smaller port, with a relatively small valve handle that is intentionally difficult to turn without using a tool. Additionally, the main valve is intentionally oriented parallel to the water pipes such that a larger valve does not protrude in a limiting fashion as the valve is rotated during installation. Shorter perpendicularly protruding ports characterized by smaller valves contribute to easier installation, while distinct valve handles prevent confusion and/or accidental opening of a water valve, especially a hot water valve that could spray onto a person. Installation can further be simplified by using a unique union nut that allows a service valve to be easily connected to an existing tankless water heater.

### BRIEF DESCRIPTION OF THE DRAWINGS

FIG. 1 is a perspective view of a valve assembly of the present invention.

FIG. 2 is a cross sectional view through line 2-2 of FIG. 1.

FIG. 3 is an exploded perspective view of the union in FIG. 1.

FIG. 4 is a cross sectional view through line 4-4 of FIG. 3.

FIG. 5 is a perspective view showing the union nut installed on the port.

FIG. 6 is a plan view of the union nut.

FIG. 7 is a perspective view showing the split ring installed on the port.

FIG. 8 is a plan view of the split ring.

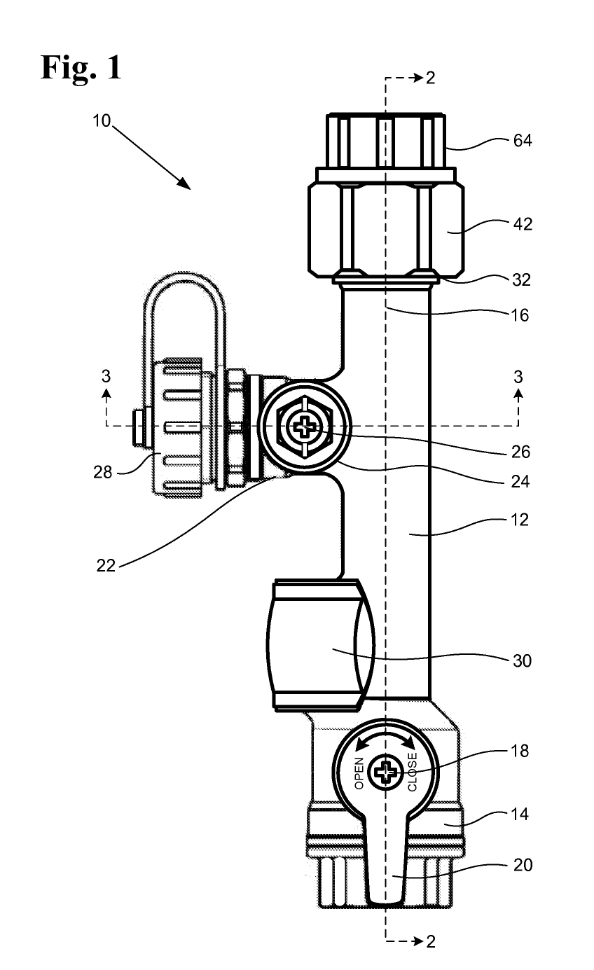

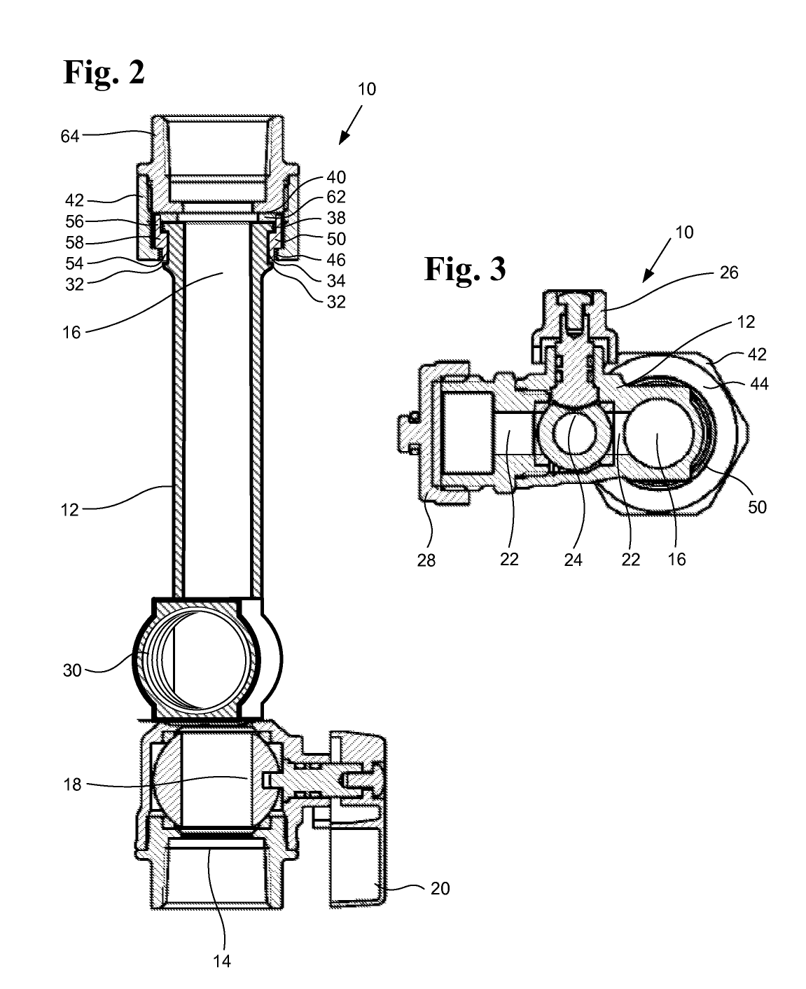

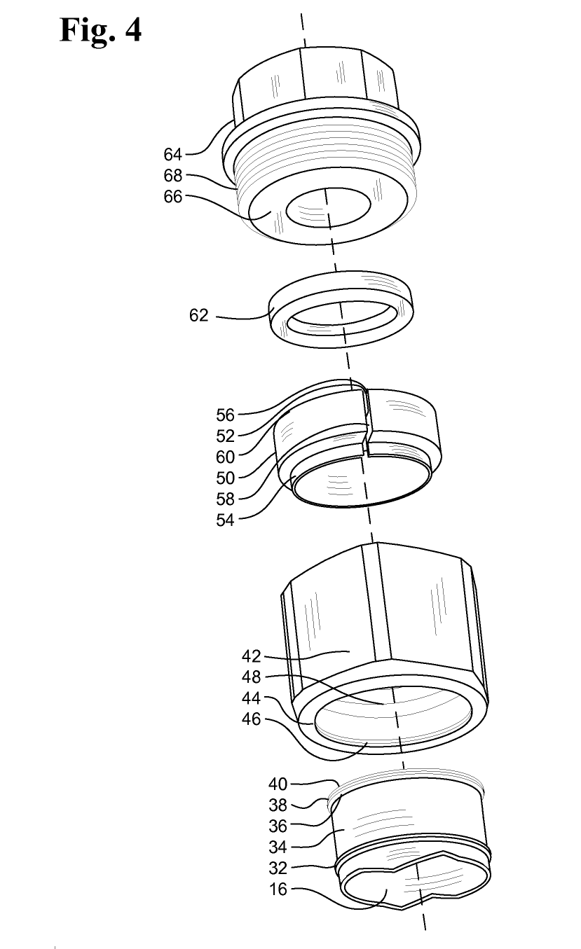

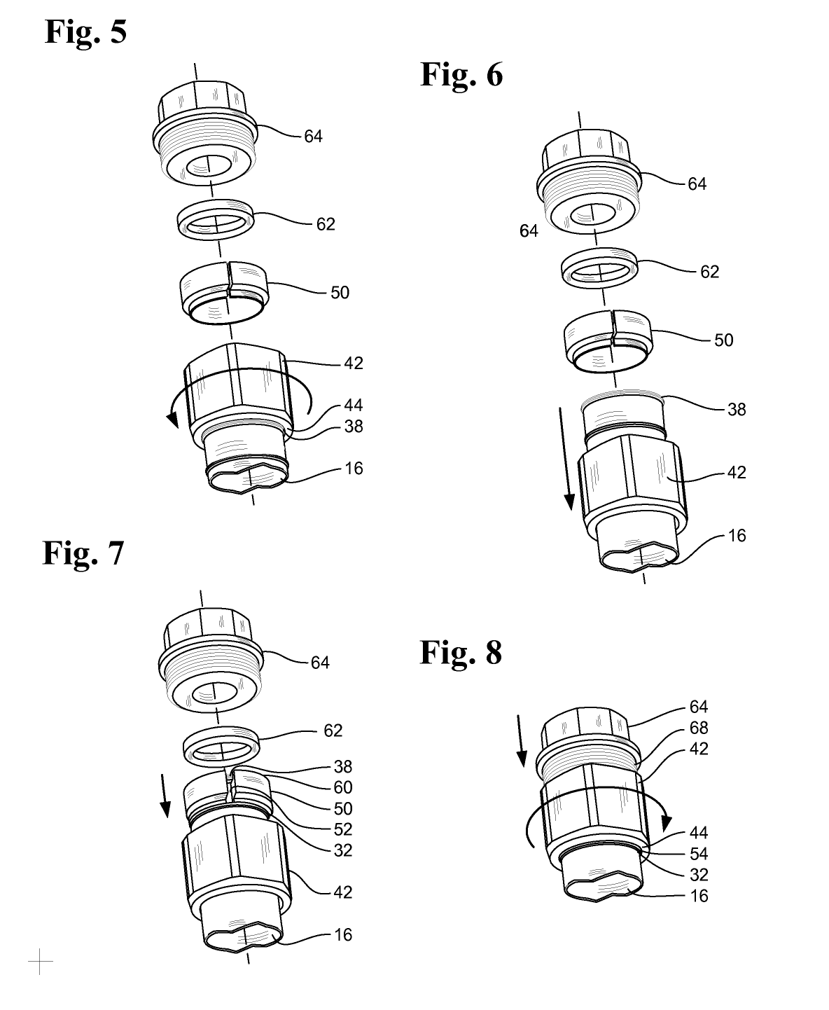

The following is the list of numerical callouts used in FIGS. 1-8:
10. Valve assembly
12. Casing
14. First port
16. Second port
18. Main valve
20. Main handle
22. Third port
24. Drain valve
26. Drain handle
28. Safety cap
30. Fourth port
32. Ridge
34. Neck
36. Flange
38. Male Installation Threads
40. First Seat
42. Union Nut
44. Shoulder
46. Female Installation Threads
48. Female Union Threads
50. Split Ring
52. Split
54 Inner cylindrical sleeve portion
56. Outer cylindrical sleeve portion
58. Middle cylindrical sleeve portion
60. Rim
62. Washer
64. Adapter
66. Second Seat
68. Male Union Threads

### DETAILED DESCRIPTION OF THE INVENTION

This detailed description will begin by describing the relevant components of a valve assembly that incorporates the present invention, followed by a description of safety and installation features, and then the various coupler components in the order that they are installed onto the valve assembly. Where reference numbers in one figure are the same as another figure, those reference numbers carry substantially the same meaning. Preferred sizes, materials and methods of attachment will be discussed, but these preferences are not intended to exclude other suitable or functionally equivalent sizes, materials or methods of attachment.

A valve assembly 10 has a casing 12 that encases at least two valves for selectively opening or obstructing the flow of water through pathways. The casing, which includes the entire valve body, is characterized by a main pathway for connecting a main inlet to a main outlet for the flow of water through the valve assembly. The main pathway is preferably the least restrictive path through and between the largest ports, or main ports, of the valve assembly. Other secondary ports frequently branch off of the main pathway at an angle, such as 90 degrees. All of these ports are part of the valve body. The casing can be formed from any known suitable material, such as metals or plastics, which meet the demands of a particular application. When used to service water pipes, the casing is preferably cast brass to allow the valve assembly to be compatible with numerous common pipe materials without creating an electric potential that causes corrosion.

A first port 14, herein arbitrarily defined as a main port that is closest to the main valve of the valve assembly, is either an inlet or an outlet, depending on the desired direction of water flow. On a tankless water heater application, the first port of the cold water valve assembly is preferably an inlet connected to a water supply, while the first port of the hot water valve assembly is preferably an outlet connected to a faucet. The first port can terminate, at its open end, with a common connection means, such as male or female threads or a socket type connection.

A second port 16 is preferably a main port that is either an outlet or an inlet. The main valve 18, which is intermediate the first port and the second port, is characterized by a valve member, such as a ball having a passageway that can be rotated, so a main valve whose valve member is a ball is a main ball valve. The valve member, which can open or obstruct the flow of a water through the valve body, is controlled by rotating a main handle 20 that turns a stem that passes through a bonnet in the casing and directly connects to the valve member. The main handle is preferably large enough to provide adequate leverage such that a user can rotate the main handle without requiring the use of any tools. A lever arm portion, such as a lever handle, or T-handle, is preferred. A lever handle's lever arm portion extends at least 2 cm from the stem portion of the main valve such that the main handle can be easily turned by hand without needing a tool. A T-handle's lever arm portion extends across the stem portion of the main valve, preferably spanning a distance of at least 3 cm, such that the handle can easily be grasped by a user's fingers. Obviously, larger main valves or difficult to turn stem portions will require a longer lever arm portion if it is desired to be able to operate a valve by hand.

A third port 22, is incorporated into a valve body to provide access to a water system for service or maintenance by a user. On tankless water heater applications, the third port preferably protrudes perpendicularly from the main pathway through the valve body intermediate the main valve and the second port. To make installation of a valve assembly easier, especially in tight spaces, the third port should not protrude more than approximately twice the value of the outer diameter of the casing. The outer diameter of the casing should be determined by measuring around the casing at a cross-section that represents the surroundings of the chamber independent of any ports or other features of the casing. In order to accommodate a drain valve 24 that controls the flow through the third port, the third port is preferably smaller than the main ports to allow for the use of a smaller drain valve. Preferably, where ball valves are utilized in the valve assembly, the diameter of a main ball valve is at least 50% larger than the diameter of a drain ball valve. A smaller drain valve and third port that is perpendicularly protruding will not significantly contribute to the overall size of a valve assembly. This feature is particularly valuable to allow for the rotation of an entire valve assembly within an adjacent space, especially where existing water pipes are relatively fixed in location and orientation. An open end of the third port usually is characterized by male threads that can easily be connected to common hose connections, so the use of too large of a drain valve could cause the third port to perpendicularly protrude too far in a limiting manner.

The drain valve should only be open during servicing of the water system. A drain handle 26 of the drain valve preferably has a smaller profile that offers little leverage to a user, so it is very difficult to manipulate the drain valve's valve member without a tool, such as a wrench. A small hexagonal drain handle, which may also be slotted, is preferred. Most preferably, a thirteen millimeter, or half-inch, box-end, crescent or socket wrench can easily fit onto the drain handle for opening or closing the drain valve. Because a larger hexagonal drain handle is effectively a knob that can be turned by hand, it is recommended that no larger than about a fifteen millimeter hexagonal head be used. To provide an optional means for manipulating a drain, a slotted-head may be additionally incorporated into the drain handle such that a screwdriver or even a coin may be used to manipulate the drain valve orientation, especially because these tools are readily available.

Opening the drain valve can cause water to spray onto a user, especially an unintended user, who is unaware of the potential harm the water could cause to property or persons. Making the drain handle obviously different from the main handle, as described above, should help prevent someone from accidentally opening the drain port. A safety cap 28 is additionally used to protect the drain port from dirt that may damage valve components, from leaking and from being accidentally opened. Collectively, the smaller sized third port, drain valve and drain handle make for easier installations and safer access for servicing a system that utilizes the valve assembly. When a water system is equipped with more than one valve assembly, color coded valve handles will allow a user to quickly distinguish water flow and water characteristics, such as red for hot and blue for cold. Familiar ON/OFF arrows are also beneficial.

A fourth port 30, optional, usually branching off of the main pathway somewhere between the main valve and the second port, can be provided to allow a pressure relief valve (not shown) to be installed onto the valve assembly. Pressure relief valves are usually not needed on a cold water valve because cold water supplies are expected to operate within a safe range of pressures. Additional or alternate ports, most commonly outlets, can be incorporated onto a valve body as needed. Because pressure relief valves can be relatively long, they protrude too far away from the valve assembly. In order to minimize this protrusion, the fourth port is preferably characterized by female threads. The fourth port can be larger in diameter than the diameter of the chamber, such that a female threaded portion of the fourth port is at least partially adjacent the chamber. Any suitable connection means can be formed or installed at an open end of any of the ports.

Most preferably, at least the second port of the above described valve assembly has a rotatable union nut installed over the port, without requiring the use of any tools. Brass, which is the preferred material for forming the valve casing, is cast, forged and/or machined to produce a desired shape. Unlike some other materials, it is not effective to try to flare or crimp the open end of a brass port to secure a union nut over the port such that the union nut rotates freely and can be threaded into a male fitting to be connected to the valve assembly. Instead, the following description explains how to make and install a rotatable union nut on a valve port.

A ridge 32 is formed around the exterior of the port such that a neck 34 is defined near the open end of the port. The neck is preferably machined, along with the other features described in this paragraph, such that a cast part that has not yet been machined probably is not characterized by any of these features. Adjacent the open end of the port is an outwardly flaring flange 36, characterized by a larger diameter than at least the neck and ridge, formed to include male installation threads 38. The male installation threads are preferably just a few projecting helical ribs having a fine pitch. It should be noted that the ridge and flange probably are not defined until after the neck has been machined into the port. The open end of the port terminates at a first seat 40 that has a flat and smooth face.

A union nut 42 is preferably made of brass, but it could also be copper, steel, iron or other metal that is compatible with a material being joined to, or it could be plastic, such as PVC. The union nut has an inwardly flaring shoulder 44 characterized by female installation threads 46 that are cut into the inner-most diameter of the shoulder. The diameter of the shoulder is too small to slip over the port on the valve body unless the female installation threads are screwed onto the male installation threads on the flange of the port. After several turns, the shoulder of the union nut is completely threaded over the flange of the port until the union nut freely slips past the neck and ridge on the port, no longer in threaded engagement. As is more common, the union nut is multi-sided, such as a hexagon, and characterized by female union threads 48. The nominal diameter hole of the union nut is greater than the largest diameter of the shoulder, so the female union threads easily slide over the flange on the port.

After sliding the union nut over the port, a split ring 50 is installed around the neck of the port. The split ring is preferably a dielectric material, such as a strong plastic. The split ring is formed as two or three concentric offset cylindrical sleeves that do not have a continuous circumference because there is a split 52 that allows the split ring to be opened into a larger circumference. While the split ring is opened, it can pass over the flange on the port until it is positioned around the neck. Releasing the split ring will cause it to close around the neck such that an inner cylindrical sleeve portion 54 lies between the ridge and the flange of the port. An outer cylindrical sleeve portion 56 of the split ring partially covers the inner cylindrical sleeve portion, and fully covers the male installation threads on the port. A middle cylindrical sleeve portion 58, if needed, joins the inner and outer cylindrical sleeve portions. With the split ring installed, the union nut can be partially drawn over the split ring until the shoulder of the union nut abuts an end of the outer cylindrical sleeve portion, against which the union nut can freely rotate. The shoulder is centered about the port by the inner cylindrical sleeve portion, which also serves to prevent the union nut from coming into electrical contact with the valve casing.

A washer 62, most preferably made from rubber or other similar flexible material, is installed against the first seat 40. The outer cylindrical sleeve portion of the split ring can extend beyond the end of the port such that a rim 60 can be used to centrally align the outer diameter of the washer. The inner diameter of the washer should be approximately the same size as the water pathway at the end of the port.

An adapter 64, which is preferably made from a compatible or similar material as the union nut, is characterized by a second seat 66 that is positioned against the washer. The union nut can then be screwed to male union threads 68 on the adapter until the first and second seats are tightened against the washer. The other end of the adapter can be any desired connection means, such as a threaded connection or socket connection. Installation of a preferred service valve assembly can be performed by rotating the service valve to threadedly connect the first port to water pipes that are not able to be rotated, and then by using the above described union nut to connect the second port to the tankless water heater.

While a preferred form of the invention has been shown and described, it will be realized that alterations and modifications may be made thereto without departing from the scope of the following claims.

What is claimed is:

1. A valve assembly for a tankless water heater comprising:
a casing having a first port, a second port and a third port;
a main valve in the first port;
a drain valve in the third port;
a main handle connected to the main valve, the main handle characterized by a lever arm portion; and
a drain handle connected to the drain valve, the drain handle not characterized by a lever arm portion.

2. The valve assembly of claim 1 wherein the main handle is a lever handle that extends at least two centimeters from a stem portion of the valve such that the main handle can be turned by hand, without needing a tool.

3. The valve assembly of claim 1 wherein the main handle is a T-handle that extends at least three centimeters across a stem portion of the main valve such that the main handle can be turned by hand, without needing a tool.

4. The valve assembly of claim 2 wherein the drain handle is characterized by a size and shape that is extremely difficult to turn without the use of a tool, such as a wrench or screwdriver.

5. The valve assembly of claim 4 wherein the drain handle is characterized by a fifteen millimeter or smaller hexagonal and/or slotted head.

6. The valve assembly of claim 4 wherein, without the use of a tool, leverage can be applied to the main handle at least three times farther away from the valve stem as compared to the leverage that can be applied to the drain handle.

7. The valve assembly of claim 2 further comprising a removable safety cap secured over an end of the third port.

8. The valve assembly of claim 2 further comprising color coding that indicates whether a valve assembly services hot or cold water.

9. The valve assembly of claim 4 wherein the main valve is a ball valve.

10. The valve assembly of claim 7 further comprising a union nut that can slide over the second port enough to completely expose a seat of the second port during installation of the valve assembly.

11. A valve assembly for a tankless water heater comprising:
a casing having a chamber, a first port, a second port and a third port;
a main valve in the first port;
a drain valve in the third port;
wherein the third port is substantially perpendicular to a flow of water through the chamber, the first port and the second port; and
wherein the third port protrudes by not more than twice the value of the outer diameter of the casing that surrounds a portion of the chamber.

12. The valve assembly of claim 11 further comprising a union nut that can slide over the second port enough to completely expose a seat of the second port during installation of the valve assembly.

13. The valve assembly of claim 12 further comprising a split ring made from a dielectric material, the split ring being installed over a neck of the second port such that the union nut can seat against the split ring.

14. The valve assembly of claim 11 further comprising a removable safety cap secured over an end of the third port.

15. The valve assembly of claim 11 further comprising a fourth port characterized by a female threaded portion that is at least partially adjacent the chamber, and wherein the inner diameter of the fourth port is larger than the diameter of the chamber.

16. A valve assembly for a tankless water heater comprising:
a casing having a chamber, a first port, a second port and a third port;
a main ball valve in the first port;
a drain ball valve in the third port; and
wherein the diameter of the main ball valve is at least fifty percent larger than the diameter of the drain ball valve.

17. The valve assembly of claim 16 further comprising a union nut that can slide over the second port enough to completely expose a seat of the second port during installation of the valve assembly.

18. The valve assembly of claim 17 further comprising a split ring made from a dielectric material, the split ring being installed over a neck of the second port such that the union nut can seat against the split ring.

19. The valve assembly of claim 16 further comprising a fourth port characterized by a female threaded portion that is at least partially adjacent the chamber, and wherein an inner diameter of the fourth port is larger than a diameter of the chamber.

20. The valve assembly of claim 16 wherein the casing is a one-piece brass construction.
